(19) United States
(12) Patent Application Publication
(10) Pub. No.: US 2007/0008732 A1
(43) Pub. Date: Jan. 11, 2007

(54) Illuminated bedrail for pickup trucks

(76) Inventors: Jonas J. Robertson, Harvey, LA (US); Robert M. Currie, Dollard-Des-Ormeaux (CA); Problems Currie, Pollack, LA (US)

Correspondence Address: Merek, Blackmon & Voorhees, LLC, 673 S. Washington St., Alexandria, VA, 22314, US

(21) Appl. No.: 11/447,061

(22) Filed: Jun. 6, 2006

Related U.S. Application Data
(60) Provisional application No. 60/687,308, filed on Jun. 6, 2005.

(51) Int. Cl. B60Q 1/00

(52) U.S. Cl. 362/459

(57) ABSTRACT

An illuminated translucent device including lighting at least one end thereof and a channel or passage therethrough or therealong for installing connecting electrical wiring therein. A method for installing the lighting such that the outer wall of the lighting means is coextensive with the housing containing the lighting means such that the light means is flush with and either coplanar (flat housing) or having substantially the same curvature (arcuate housing) as the housing.

This application claims the benefit of Provisional Application Ser. No. 60/687,308 filed Jun. 6, 2005.

### FIELD OF THE INVENTION

The present invention relates generally to translucent or transparent devices having illumination sources therewith. More particularly, the present invention comprises an elongate, translucent element having an electrically powered lighting source illuminating the translucent element from one or both ends thereof, wherein the illuminating element is flush mounted with the surface in which the element is mounted. Also disclosed is a method of mounting a light wherein the light is mounted to a standard geometric shaped receiver having a cutout for the light element.

### BACKGROUND OF THE INVENTION

Elongate tubular and cylindrical rod supports, columns, stands, rails, bannisters, etc., are conventionally used in a multitude of widely varying devices and structures. Examples of such are poles or columns for floor lamps; columns for suspending ceiling fans and ceiling mounted lights therefrom; tubular bumper and grille guard structures in motor vehicles, particularly for pickup trucks and sport utility vehicles; roof racks, laterally mounted steps, and the like for such vehicles; and bridge, highway, and other guardrails, bannisters, and balusters. While the above list is relatively comprehensive, it should be understood that it is not all-inclusive, and that many other elongate structural elements are known.

A universal characteristic of such elongate elements, is their lack of internal or integral lighting therewith. This is an important consideration, widely recognized by traffic engineers. It is common for such structures to be illuminated by reflective or phosphorescent tape, paint, or other means when used in the highway or roadway environment, and/or to provide external flood or spot lighting of such structures to alert motorists as to their location and proximity. Also, motor vehicles themselves are universally fitted with various lighting elements, particularly larger trucks with their side mounted clearance lighting. However, where other structural assemblies are provided, e.g., bumper and grill guards, rollover structures and roof racks, etc., they are universally lighted with only reflective elements, if at all.

A universal characteristic of such structures and devices is their lack of integral illumination to provide internal lighting from the device or structure itself, as noted above. Heretofore, when the need for illuminating such structures was perceived, all lighting has been accomplished by means of additional external, supplementary lighting directed at the structure or device, and/or the application of reflective or phosphorescent coatings to the structure or device.

Accordingly, a need will be seen for illuminated translucent structures and devices, comprising an elongate translucent or transparent member. The exterior of the translucent member may be covered by a generally solid structural tubular member for greater structural strength, with the tubular member having one or more light passages formed therethrough.

Additionally, in a preferred form, the light member is made of acrylic or similar plastic. The housing surrounding the light is preferably formed by taking a regular geometrically shaped member such as a cylinder, and removing a portion of the cylinder, and replacing the removed section of the cylinder with an acrylic portion sized to replace the removed section.

In another preferred embodiment, the light receiving member is formed to approximate a regular geometric shape with a section removed and having a light receiving member for receiving a light shaped to complete the regular geometric shape.

All of the above described devices are easily illuminated by means of light emitting diodes (hereinafter known as “LEDs” throughout the remainder of the disclosure), or other lighting sources, as desired. The provision of electrical conductors extending through or along the translucent member, enables LEDs or other lighting sources to be installed at various points along the assembly, to maintain illumination along the entire assembly.

### SUMMARY OF THE INVENTION

The present invention comprises an illuminated translucent device, having an elongate translucent body which is illuminated at, at least one end and may include other illumination locations along the length thereof. A first end may include a first lighting element therewith, oriented to direct light into the end of the translucent body, and may have another lighting element at the opposite end of the translucent member. The translucent member may include a passage or channel for an electrical conductor(s) for providing power to the distal second lighting element at the opposite end or at a location removed from the first lighting element.

The present invention may also be combined with a solid, opaque tubular member installed thereover, to provide the desired structural strength for use in bed rails, vehicle bumpers and grille guards and other similar structures. The opaque external member can include a light passage formed through the wall thereof, allowing light to escape from the translucent member therein to illuminate the structure. Different colored lighting, including control by timer or other means, may be applied to any of the embodiments of the present invention as desired.

### OBJECTS OF THE INVENTION

Accordingly, it is a principal object of the invention to provide an elongate translucent member having first lighting source at a first end thereof and may also include secondary lighting source at a distal location therein or at a distal second end thereof, for energizing the distal secondary lighting source.

It is another object of the invention to provide such illuminated translucent devices incorporating various lighting principles, but most preferably incorporating LED lighting therewith, with the LED lights directed into the ends of the translucent member.

It is a further object of the invention to provide an opaque structural member surrounding the central translucent element, with the opaque structural member having at least one light passage formed through the wall thereof.

Still another object of the invention is connecting a supplemental lighting system to the bedrail of a pickup truck or other vehicle.

It is another object of the invention to manufacture a lighting system such that the acrylic light portion is part of the structural portion of the light system such that the non-lighted portion and the lighted portion together make a regular geometric shape light system.

These and other objects of the present invention will become apparent upon review of the following specification and drawings.

It must be understood that no one embodiment of the present invention need include all of the aforementioned objects of the present invention. Rather, a given embodiment may include one or none of the aforementioned objects. Accordingly, these objects are not to be used to limit the scope of the claims of the present invention.

### BRIEF DESCRIPTION OF THE DRAWINGS

FIG. 1 is a perspective view of a first embodiment of the present invention, mounted on a bedrail of a pickup truck.

FIG. 2 is a perspective view of the lighting fixture.

FIG. 3 is a cross sectional view taken along lines 3-3 of FIG. 2.

FIG. 4 is perspective view of an end cap of the lighting fixture showing a light source mounted in the end cap.

FIG. 5 is an cross sectional view of a mounting device for mounting the lighting fixture to the bed rail of a pickup truck.

Similar reference characters denote corresponding features consistently throughout the attached drawings.

### DETAILED DESCRIPTION OF THE INVENTION

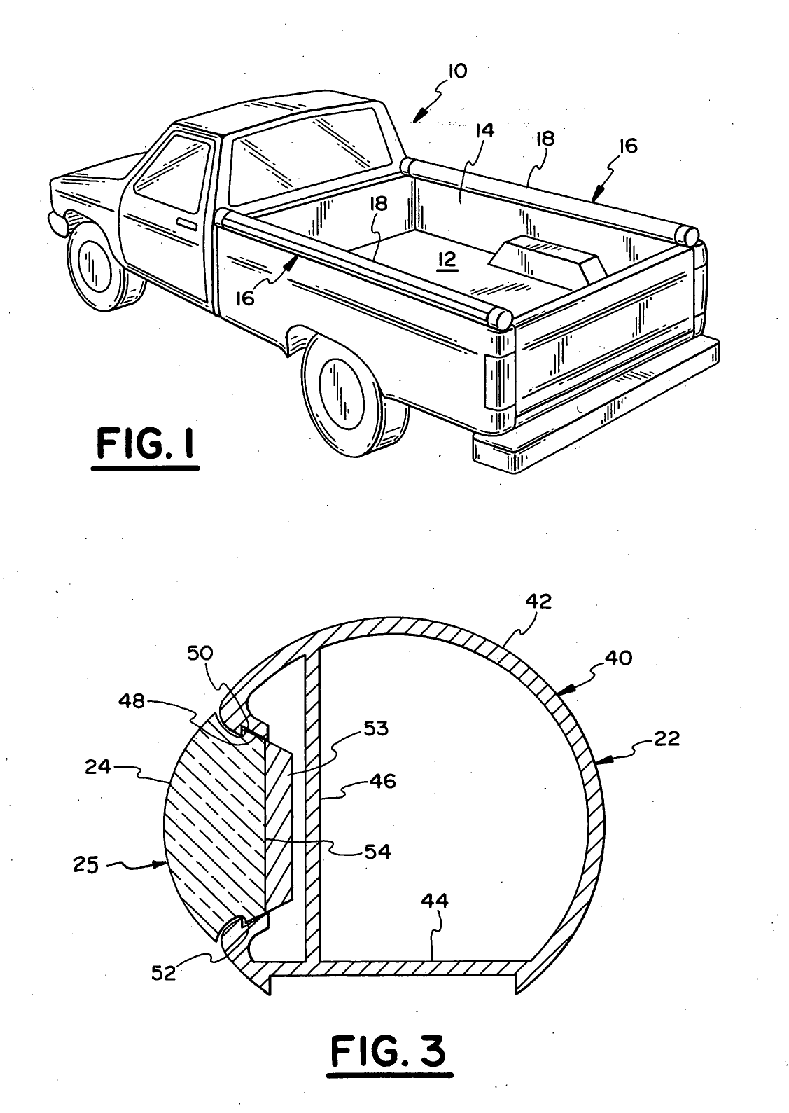

The most preferred forms of the invention will now be described with reference to FIGS. 1-5. The appended claims are not limited to the most preferred forms and no term used herein is to be given a meaning other than its ordinary meaning unless accompanied by a statement that the term “as used herein is defined as follows”.

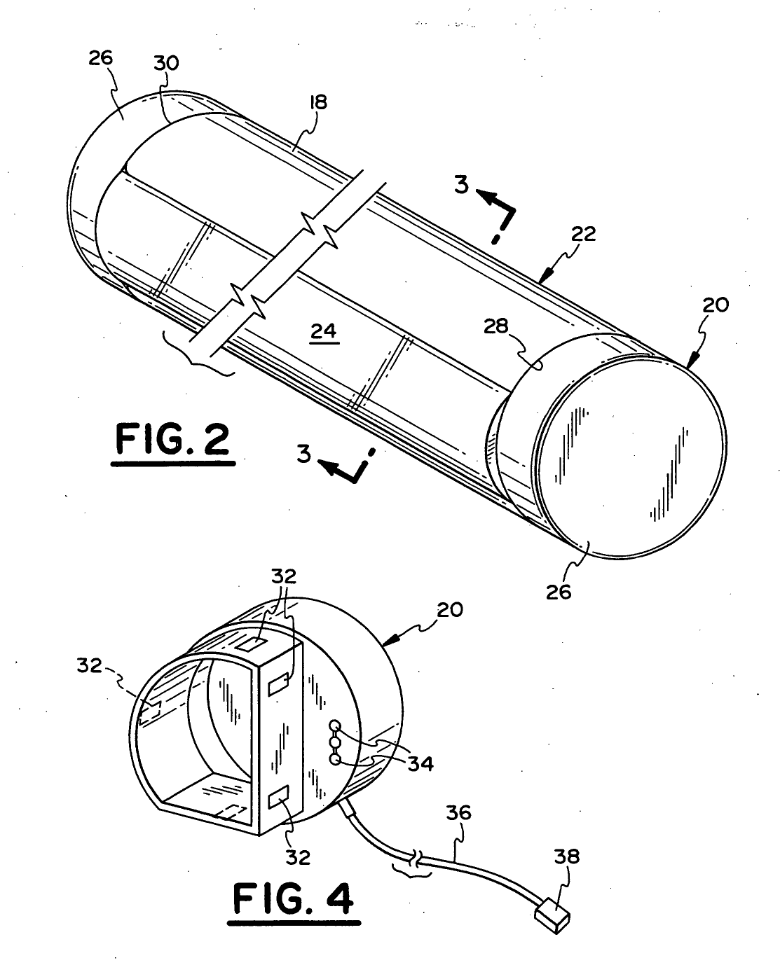

Now with references to FIG. 1, a pickup truck 10 having a bed 12 with bed rails 14 is shown incorporating the illumination rails 16 of the present invention mounted on the bed rails 14. The illumination rails 16 include a main body portion 18 and may preferably include one or two end caps 20 as shown in FIGS. 2 and 4. The main body portion 18 includes a support bracket 22 preferably formed of aluminum, but may also be constructed of any material of sufficient rigidity to hold its shape such as plastic or metal and support a translucent or transparent light transmitting bar 24 preferably formed of solid plastic material such as that sold under the name of LUCITE®. Preferably, the light transmitting bar 24 extends the length of the main body portion 18. An end cap 26 is preferably located at each end 28, 30 of the main body portion 18. Illumination of the light transmitting bar 24 is preferably effected by a light emitting diode (LED) in at least one of the end caps 20. Each of the end caps 20 include connectors 32 for connecting the end caps 20 to main body portion 18 and further include the light source 34 which preferably is a light emitting diode. An electric cord 36 supplies electricity to the light source from an electrical connection 38 which connects to an electrical source on the vehicle 10. Alternatively, the electric cord 26 may be spliced into a power supply wire of the vehicle's electrical system. Preferably, the light transmitting bar is operable in conjunction with the headlights of the vehicle 10 so that power to the bar 10 can be turned on and off with the headlights, but may also operate in conjunction with parking lights or tail lights.

Now looking at FIG. 3 which is a cross-section of the main body portion 18 taken along lines 3-3 of FIG. 2, it can be seen that support bracket 22 includes a rigid housing wall 40 forming an arc 42 having a flat bottom wall 44, a vertical support wall 46 and a retention groove 48 for retaining the light transmitting bar 24. The retention groove 48 includes notches 50 which correspond to lands 52 on the light transmitting bar 24 which allows the light transmitting bar 24 to slide lengthwise into the retention groove 48 and be securely retained therein.

In order to maximize the amount of light emitted from the light transmitting bar 24, a reflective coating 53 is applied to the back side 54 of light transmitting bar 24. the reflective coating is preferably a layer of reflective plastic material or reflective paint.

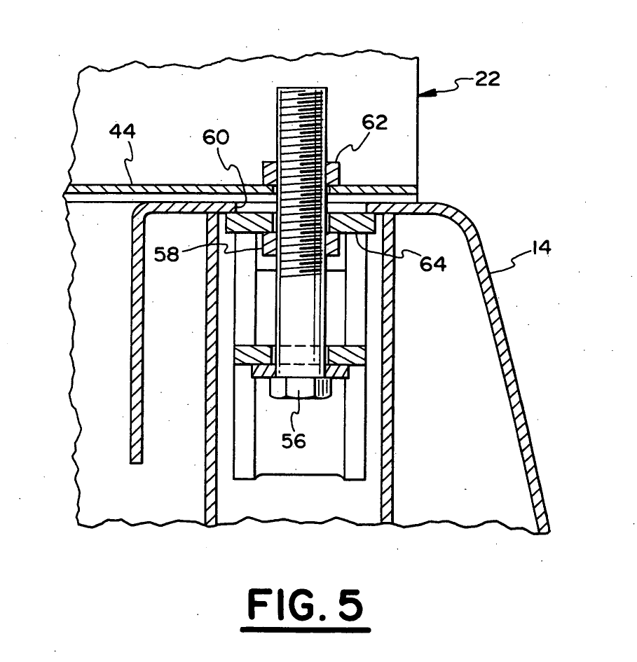

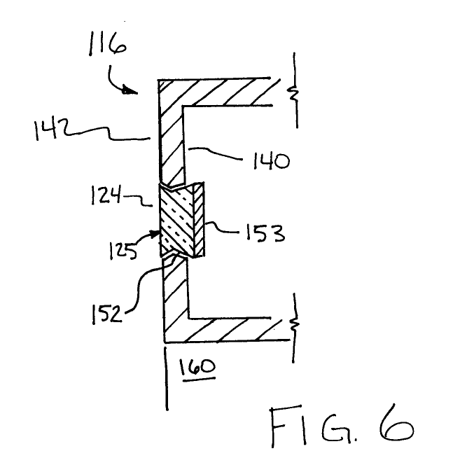

The main body portion is preferably attached to the bed rails 14 by a conventional hold down arrangement as shown in FIG. 5. As can be seen in FIG. 5, a threaded bolt 56 extends through a threaded fastener 58 inserted in an opening 60 of a conventional pickup truck bedrail 14. The bottom wall 44 of support bracket 22 also includes a threaded fastener 62 for receiving the threaded bolt 56. The fastener 58 is formed as part of an insert 64 which is large enough to be retained within the opening 60 when bolt 56 is connected to fastener 58 of bottom wall 44 and thus retaining the support bracket 22 on bed rail 14.

The above described invention may incorporate additional circuitry enabling the colors of the lighting to be varied or changed, as desired. Such additional circuitry may incorporate an emergency electrical power supply, with the device being well suited for use as an emergency lighting system when so equipped. In addition, further circuitry may be incorporated with any of the embodiments of the present invention to cause the lights to flash or vary in intensity in accordance with audio input, if so desired, or set in a “chase” pattern. Such variable lighting intensity according to audio input may be applied to wall sconces and other decorative illuminating devices and for use in apart from vehicles and wherever such a display might be desired. Thus, the present invention in any of its embodiments provides a novel and attractive means for illuminating a wide variety of different devices and areas for decorative or other purposes, as desired.

In a preferred embodiment, the lights 24 are mounted flush with the outer wall of the rails. Where the rails 16 are cylindrical shape (and therefore have a circular cross-section) above the bed walls of a pickup truck 10, for example, the light member 24 is configured to have an outer wall shaped 25 to mimic the railing by having substantially the same curvature as the rail in which it is mounted. In other words, if the walls of the cylinder are defined as an arc having a diameter of X from the longitudinal axis of the railing member, then the outer wall of the lighting member is also defined as an arc having a diameter of X from the central axis of the railing member. In this way, during the day time hours the railing 16 will have a continuous shape uninterrupted by a flat lighting member or by other slots or light holding members that deviate from the natural shape of the railing. The light member in effect becomes a part of the railing structure by being mounted co-extensive with and flush to the outer wall of the railing.

In practice, the railing 16 and lighting member 24 are formed as matching pairs. A railing having a mostly circular cross section (FIG. 1), such as a cylinder, is formed with a first diameter. A portion of the cylinder is removed or more preferably formed with a portion of the cylinder missing. As shown in FIG. 3, preferably a set arc of the circumference is removed for substantially the entire length of the railing. Portions of the railing housing 18 may have not have the portion removed for structural reasons. Inside the length of the portion of the open railing where the piece of the railing is missing, tracks or notches 50 or other means are provided to receive and lock the lighting member within the railing as described above. The lighting member 24 is then formed as having an outer curved wall 25 defined by a diameter substantially equal to the diameter of the railing arc 42. The lighting member preferably has a outer wall defining arc 25 substantially the same as that removed or missing from the railing, such that when in place, the light will be substantially flush with and contiguous with the railing. The inner dimension 54 of the lighting member is formed to not interfere with the railing, especially if one or more internal walls 46 has been formed within the railing to bolster the rigidity of the railing or to provide an internal channel for electrical cables or other members to be run within the separate channel. The lighting member 24 as discussed above preferably is side lit acrylic. The acrylic preferably has a reflecting surface such as white, reflective tape at its interior surface to direct the light outward. If the internal railing walls 46 formed within the railing are sufficiently close to the light member and if the surface has a sufficiently reflective surface, the railing member itself can reflect the light outwardly. As discussed above, the lighting for the light member can be provided by LED members or other lights which are directed axially down the light bar 24 to provide lighting radially outward from the light member.

In a like manner, if the railing cross-section is square or rectangular as shown in FIG. 6, the outer face 125 of the light member 124 will have an outer wall coplanar with the outer wall 142 of the railing 116 in which the light member is situated. This configuration of the light member as having an outer wall flush, coplanar (i.e., rectangular rails), having substantially the same curvature or substantially curvature (i.e., arcuate rails), or coextensive with the outer wall of the railing or light receiving member is defined herein as being “flush mounted.”

In this way the flush mounted light member appears to be a part of the railing structure 140 itself. An interference fit may be used wherein the side walls 152 of the reflector are slight larger than the opening in the railing wall 142 causing the reflector to frictionally wedge in the railing wall. Reflector tape or other reflective means 153 are provided at a back wall of the reflector in a similar method as described above. In this way, the reflector is flush mounted to the railing. This may be particularly advantageous if the railing 116 is attached to a vehicle 160 such as a semi (“eighteen wheeler”) or other box truck that has railing built into its walls. Lighting can thus be incorporated into the truck railing without departing from the natural look and shape of the truck railing while providing energy efficient lighting to outline, for example, the truck trailer or box truck outer perimeter. Of course, one skilled in the art would recognize that the environment described in merely exemplary, and that the railing could be in a house, a bridge, roadside traffic type railing, or various other housings.

While this invention has been described as having a preferred design, it is understood that it is capable of further modifications, uses and/or adaptations of the invention following in general the principle of the invention and including such departures from the present disclosure as come within the known or customary practice in the art to which the present invention pertains and as maybe applied to the central features hereinbefore set forth, and fall within the scope of the invention and the limits of the appended claims.

1. An illuminated light bar assembly, comprising:
a) a support having a channel for receiving a light transmissive rod;
b) said channel and said rod having cooperating structures which allow a connection portion of said rod to slide in said channel and be retained therein while a light transmissive portion of said rod extends outwardly of said channel;
c) at least one light emitting diode operatively associated with said light transmissive rod for providing light to illuminate said light transmissive rod;
d) a switch electrically connected to said light emitting diode for supplying power to said diode and causing light to be emitted.

2. The illuminated light bar assembly as set forth in claim 1, wherein:
a) said support includes a truck bed rail attachment.

3. The illuminated light bar assembly as set forth in claim 1, wherein:
a) said light transmissive rod is formed of solid plastic material.

4. The illuminated light bar assembly as set forth in claim 1, wherein:
a) said cooperating structures include interlocking grooves on said light transmissive rod and said channel.

5. The illuminated light bar assembly as set forth in claim 1, wherein:
a) said at least one light emitting diode is located in an end cap adjacent one end of said light transmissive rod and said diode is positioned to emit light directly toward said one end so that light from said diode is directed along the entire length of said rod.

6. An illuminated light bar for attachment to a pickup truck bed rail, comprising:
a) a support having a channel for receiving a light transmissive rod;
b) said channel and said rod having cooperating structures which allow a connection portion of said rod to slide in said channel and be retained therein while a light transmissive portion of said rod extends outwardly of said channel;
c) at least one light emitting diode operatively associated with said light transmissive rod for providing light to illuminate said light transmissive rod;
d) a switch electrically connected to said light emitting diode for supplying power to said diode and causing light to be emitted.

7. The illuminated light bar as set forth in claim 6, wherein:
a) said support is elongated and includes a base for resting upon a bed rail of a pickup truck and said channel extends in a substantially parallel relationship to said bed rail when said elongated support is installed upon said bed rail.

8. The illuminated light bar as set forth in claim 6, wherein:
a) light transmissive rod is elongated and formed of solid plastic material.

9. The illuminated light bar as set forth in claim 6, wherein:
a) said cooperating structures include interlocking grooves on said light transmissive rod and said channel.

10. The illuminated light bar as set forth in claim 6, wherein:
a) said switch includes an electronic connection adapted to cooperate with a vehicle lighting system to permit operation of said illuminated light bar simultaneously with said vehicle lighting system.

11. The illuminated light bar as set forth in claim 10, wherein:
a) said vehicle lighting system includes headlights and said illuminated light bar assembly is operable when said headlights are switched on.

12. The illuminated light bar as set forth in claim 10, wherein:
a) said vehicle lighting system includes parking lights and said illuminated light bar assembly is operable when said parking lights are switched on.

13. The illuminated light bar as set forth in claim 10, wherein:
a) said vehicle lighting system includes tail lights and said illuminated light bar assembly is operable when said tail lights are switched on.

14. The illuminated light bar as set forth in claim 10, wherein:
a) said base includes a connection device for securely attaching said base to the bed rail of a pickup truck.

15. The illuminated light bar as set forth in claim 6, wherein:
a) said at least one light emitting diode is located in an end cap adjacent one end of said light transmissive rod and said diode is positioned to emit light directly toward said one end so that light from said diode is directed along the entire length of said rod.

16. An illuminated light bar assembly for attachment to a bed rail of a pickup truck, comprising:
a) an elongated support having a channel for receiving an elongated light transmissive rod, said channel and said rod being of substantially equal length;
b) said channel and said rod having cooperating structures which allow a connection portion of said rod to slide in said channel and be retained therein while a light transmissive portion of said rod extends outwardly of said channel along the entire length of said channel;
c) an end cap attached to a first end of said elongated support said end cap containing at least one light emitting diode operatively positioned to direct its light output into a first end of said light transmissive rod for providing light to illuminate said light transmissive rod;
d) a switch electrically connected to said light emitting diode for supplying power to said diode and causing light to be emitted.

17. The illuminated light bar assembly as set forth in claim 16, wherein:
a) said support includes a truck bed rail attachment.

18. The illuminated light bar assembly as set forth in claim 16, wherein:
a) said light transmissive rod is formed of solid plastic material.

19. The illuminated light bar assembly as set forth in claim 16, wherein:
a) said cooperating structures include interlocking grooves on said light transmissive rod and said channel.

20. The illuminated light bar assembly as set forth in claim 16, wherein:
a) said base includes a connection device for securely attaching said base to the bed rail of a pickup truck.
